(19) United States
(12) Patent Application Publication
(10) Pub. No.: US 2020/0073777 A1
(43) Pub. Date: Mar. 5, 2020

(54) Method for Automatically Evaluating Alarm Clusters

(71) Applicant: Siemens Aktiengesellschaft, Muenchen (DE)

(72) Inventor: Benjamin Lutz, Pfinztal (DE)

(21) Appl. No.: 16/553,351

(22) Filed: Aug. 28, 2019

(30) Foreign Application Priority Data
Aug. 29, 2018 (EP) 18191413.6

(51) Int. Cl. G06F 11/32; G05B 23/02; G08B 29/02; G05B 19/406

(52) U.S. Cl. CPC G06F 11/327; G05B 23/0272; G05B 2219/31469; G05B 23/0278; G05B 19/406; G08B 29/02

(57) ABSTRACT

A method for identifying an output alarm message of an alarm message cluster in a management system of a technical installation is proposed, wherein alarm messages arriving in the management system of the technical installation are detected and stored in a storage device, a specific time range is defined for further processing the alarm messages contained in the time range, at least one time instant within the time range, at which an output alarm message arrives in the technical installation is determined, and the at least one specific time instant is transmitted to a control device, which is embodied to display the alarm messages.

### BACKGROUND OF THE INVENTION

### 1. Field of the Invention

The invention relates to a method for identifying an output alarm message of an alarm message cluster in a management system of a technical installation, and to an operation station server of the management system of the technical installation.

### 2. Description of the Related Art

An efficient alarm management is of central importance for the control and visualization of technical installations by operators. What is known as a message sequence display represents a particularly helpful tool in this context. This is a (tabular) listing of alarms that are sorted according to certain criteria (e.g., according to their time stamp). Historical alarms can also be shown here alongside current alarms. For this purpose, a specific time range is generally predetermined.

For instance, alarms can be loaded from a file into the message sequence display over a time frame of an hour. In large technical installations, this may easily involve hundreds of alarms that cannot all be shown to an operator at the same time. In contrast, the visualized range of the message sequence display is often significantly smaller than the range of the message sequence display actually observed. The operator must therefore navigate through the non-visualized regions. Here, the operator reaches his/her limits should an alarm cluster (also known as an alarm surge) occur.

With such an alarm cluster, there is generally an output alarm (known as the trigger alarm), which is followed by numerous additional alarms. For instance, a stuck valve can trigger such an output alarm. As a result of this, numerous sensors (temperature, flow rate) assigned to the valve, or actuators, output follow-up alarms within a short period of time. The operator now has the challenge of identifying the output alarm from a confusingly large quantity of alarm messages, in order to identify the actual cause of the alarm situation and to be able to introduce appropriate measures.

The search for the cause can be additionally hampered by further alarms being contained in the message sequence display, which have nothing to do with the particular alarm situation. In order to hide the interfering alarms during the search, special filters can be used, which must firstly be manually defined by the operator and therefore require unnecessary time. Conversely, an alarm cluster can hamper the search for other, independent alarm events, because individual alarms are covered by the bulk of the alarm cluster.

In general, an alarm cluster represents an element that places a strain on a management system of a technical installation (with respect to time and other resources), because the cause of the alarm cluster has to be identified as quickly as possible.

### SUMMARY OF THE INVENTION

It is an object of the invention to provide an improved method, which enables efficient and rapid locating of a source of a cluster of alarm messages in a management system of a technical installation.

This and other objects and advantages are achieved in accordance with the invention by a method for identifying an output alarm message of an alarm message cluster in a management system of a technical installation and by an operation station server of the management system of the technical installation, where the method in accordance with the invention includes the steps of a) detecting alarm messages arriving in the management system of the technical installation and storing the alarm messages in a storage device, b) defining a specific time range for further processing of the alarm messages contained in the time range, c) determining at least one time instant within the time range, at which an output alarm message arrives in the technical installation and d) transmitting the at least one specific time instant to a control device, which is embodied to display the alarm messages.

In the present context, a management system is understood to be a computer-aided technical system, which comprises functionalities for representing, controlling and managing a technical manufacturing or production installation. In the present case, the management system comprises sensors for determining measured values, as well as various actuators. Additionally, the management system comprises what are known as process or manufacture-oriented components, which serve to activate the actuators or sensors. Furthermore, the management system has inter alia means for visualizing the technical installation and for engineering. The term management system is additionally intended to also encompass further computer units for more complex regulations and systems for data storage and processing.

A technical installation is a plurality of machines, devices, applications and the like, which have a functional and often also spatial relationship with one another. With the installation, products, components and the like are generated or manufactured with (large-scale) technical dimensions.

An alarm message can be a message of a device in the technical installation, for instance, which contains a faulty state of the device as information.

The time range can in principle be any time range. For practicality reasons, a time range is preferred that is smaller than an entire operating duration of the technical installation. Time ranges can be selected that start and end in the past. However, the end can also be selected so that it is at a current time instant at which the method is being performed.

The specific time range can advantageously be predetermined by the control device, which is configured appropriately for this purpose.

An output alarm message is understood to mean an alarm message that includes a plurality of subsequent further alarm messages and/or other message types. For instance, a stuck valve can trigger such an output alarm message. As a result, numerous sensors assigned to the valve (temperature, flow), or actuators, also output follow-up alarms messages within a short period of time.

The inventive idea now lies in the fact that at least one time instant is determined in the previously defined time range, the time stamp of which has an alarm message that represents an output alarm message. The determined time instants are then transmitted to a control device, via which an operator of the technical installation can quickly and efficiently identify at least one output alarm message and can introduce appropriate measures.

In an advantageous embodiment of the invention, the following method steps are performed within the scope of determining the at least one time instant (compare the previously described method step c): i) totaling all active alarm messages in the time range and determining an associated totaling function, ii) identifying local minima of the totaling function, and iii) transmitting the identified local minima to the control device.

The determined totaling function provides information about which quantity of alarm messages is active at which time instant within the observed time range. It may happen that alarm messages are only active at the start of the time range and then invalid from a specific time instant. The totaling function maps this case via a corresponding reduction in the total value.

In a subsequent step, the local minima of this totaling function are determined via mathematical methods known per se. It was identified that the output alarm messages are regularly in the range of these minima and are therefore suitable as appropriate indicators.

The formation of the totaling function, the locating of the minima and the provision of the minima for the operator or the control device can occur fully automatically, which represents an enormous time saving compared with a manual locating of the output alarm messages.

The determined local minima are advantageously sorted based on a specific criterion, in particular a value according to an amount, and transmitted to the control device. By sorting the minima, an operator can navigate selectively to a specific local minimum, such as to the minimum that has the smallest value.

It is particularly preferable if an operator of the technical installation is automatically presented with the identified local minima or alarm messages using the control device, where the alarm messages are accumulated in a specific range about the local minima in the technical installation.

It is also an object of the invention to provide an operation station server in a management system of a technical installation, which is configured to perform the method in accordance with the disclosed embodiments. An “operator station server” is understood here to mean a server having a processor and memory which acquires central data of an operator control and visualization system and generally alarm and measured value files in a management system of a technical installation and makes this available to users or operators.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The afore-cited properties, features and advantages of this invention as well as the manner in which they are achieved will become clearer and more intelligible in conjunction with the following description of the exemplary embodiment which is explained in more detail with reference to the drawings, in which:

FIG. 1 shows an exemplary graphical plot of a time range in accordance with invention;

FIG. 2 is a graphical plot of the totaling function resulting from the example exemplary graphical plot of FIG. 1;

FIG. 3 is a graphical illustration of the sorting of local minima in accordance with the invention;

FIG. 4 shows a schematic block diagram of the architecture of a management system of a technical installation configured as a processing installation in accordance with the invention; and

FIG. 5 is a flowchart of the method in accordance with the invention.

### DETAILED DESCRIPTION OF THE EXEMPLARY EMBODIMENTS

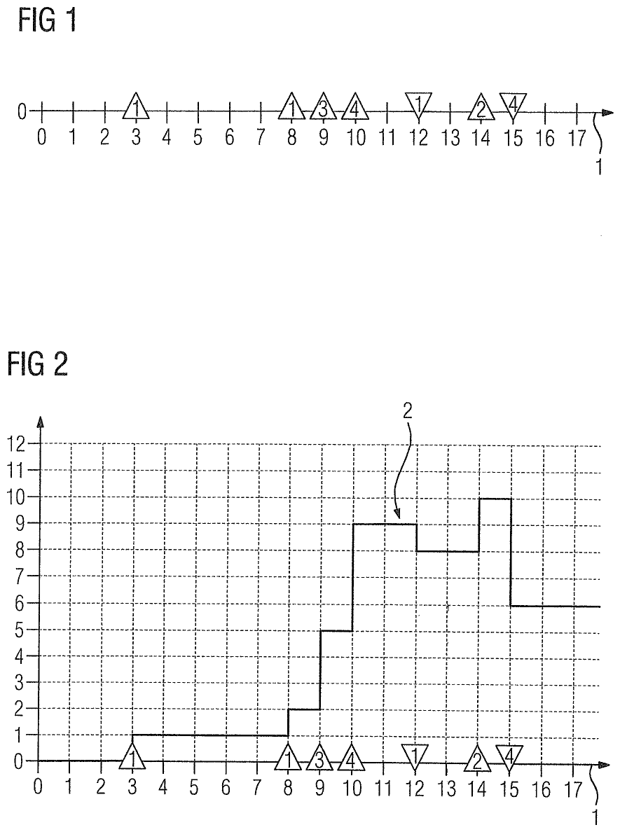

FIG. 1 shows a time range 1. The time range 1 comprises 17 individual time instants at which alarm messages, which arrive in a management system of a technical installation, are either activated (triangular symbol with upward peak) or deactivated (triangle symbol with downward peak). Here, the numbers in the triangle symbols stand for the number of newly added active or deactivated alarm messages.

Within the scope of an evaluation of these alarm messages, a totaling function 2 is determined in a first step. The totaling function 2 resulting from the example according to FIG. 1 is shown in FIG. 2. The totaling function 2 forms the number of alarm messages which are active at a specific time instant within the specific time range 1.

Based on the totaling function 2, the local minima 3a, 3b, 3c of the course of the totaling function are determined in a subsequent step. The knowledge behind the invention is therefore that output alarm messages, in other words the initial alarm messages of a cluster of alarm messages or suchlike, are potentially located in the vicinity of these local minima 3a, 3b, 3c.

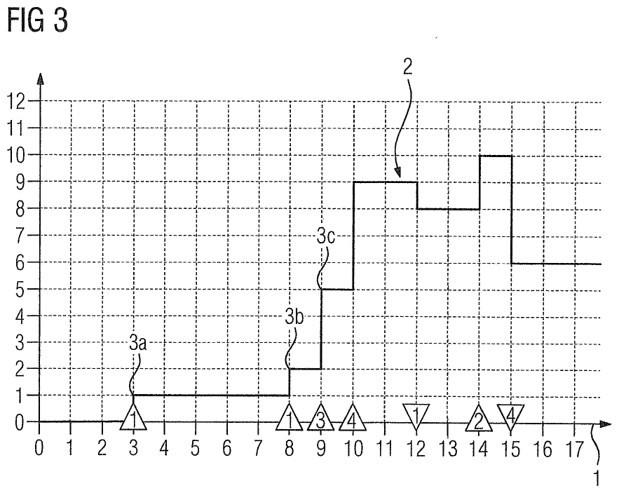

The local minima 3a, 3b, 3c are then sorted based on the value, according to amount, of the respective local minima 3a, 3b, 3c, as shown in FIG. 3. Here, the numerical value in the circle symbols of the local minima 3a, 3b, 3c indicates a sorting sequence of the local minima 3a, 3b, 3c. The local minima 3a, 3b, 3c and the corresponding time instants are transmitted to a control device in the technical installation. The control device allows an operator to selectively determine the ranges within the time range 1, which are relevant to taking appropriate measures within the context of an alarm message cluster.

A display of the control device can be configured such that a visualized partial time range of the more comprehensive time range 1 indicates a more immediate vicinity of the individual local minima. Advantageously, a range of X−10 seconds up to X+10 seconds is displayed, for instance, where an identified local minimum 3a, 3b, 3c has the time stamp X. The local minimum is accordingly visualized “in the center of the display” of the control device.

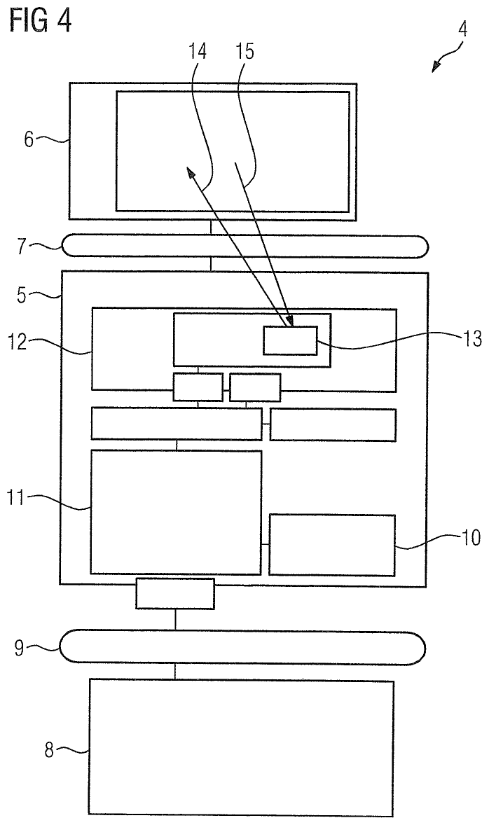

FIG. 4 shows a schematic representation of the architecture of a management system 4 of a technical installation configured as a processing installation. The management system 4 has a server of a control system or an operator station server 5.

A control device or client 6 is connected to the operator station server 5 via a terminal bus 7. The terminal bus 7 can be configured, without limitation, as an industrial Ethernet, for instance.

A device 8 is linked to the operator system server 5 via an installation bus 9. Here, the connected device 8 can alternatively also be an application, in particular a web application. Within the scope of the invention, any number of devices and/or applications can be connected to the operator system server 5. The installation bus 9 can be configured, without limitation, as an industrial Ethernet, for instance. The device 8 can in turn be connected to any number of subsystems (not shown).

The operator station server 5 comprises a process data file 10, a process image service 11 and a visualization service 12. (Alarm) messages which have been received from the connected devices 8 via the process image service 11 are inter alia retrievably stored in the process data file 10. The visualization service 12 can be used to transmit data to the control device 6 or the client 6. The inventive method explained previously is implemented via an “alarm flood evaluation service” 13, which is part of the visualization service 12 of the operator station server 5. Here, the “alarm flood evaluation service” 13 provides a user of the control device 6 with the correspondingly processed data by way of an output flow 14. The user can also send commands to the “alarm flood evaluation service” 13 in the reverse direction via an input flow 15, in order to configure its requirements appropriately.

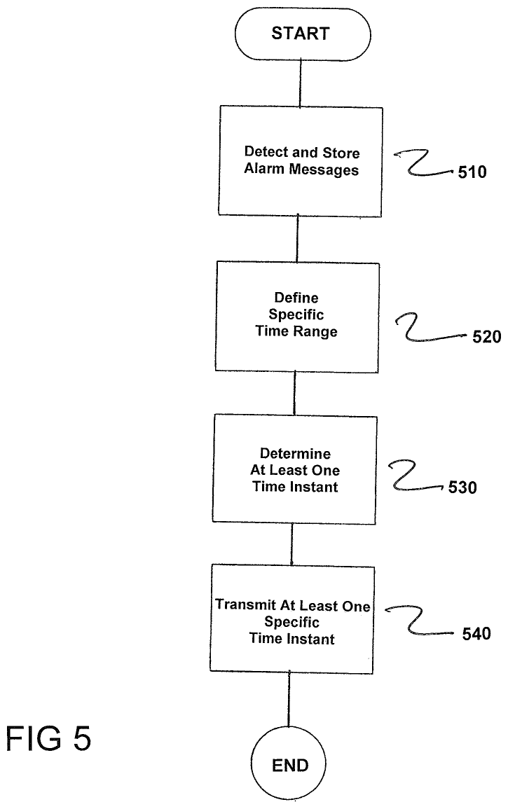

FIG. 5 is a flowchart of the method for identifying an output alarm message of an alarm message cluster in a management system 4 of a technical installation. The method comprises detecting alarm messages arriving in the management system 4 of the technical installation and storing the detected alarm messages in a storage device 10, as indicated in step 510. Next, a specific time range 1 is defined for further processing of the detected alarm messages contained in the specific time range 1, as indicated in step 520.

Next, at least one time instant, within the specific time range 1, at which an output alarm message arrives in the technical installation is determined, as indicated in step 530.

Next, the at least one time instant is transmitted to a control device 6, which is configured to display the detected alarm messages, as indicated in step 540.

Although the invention has been illustrated and described in detail with the preferred exemplary embodiment, the invention is not restricted by the examples disclosed and other variations can be derived therefrom by a person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for identifying an output alarm message of an alarm message cluster in a management system of a technical installation, the method comprising:
a) detecting alarm messages arriving in the management system of the technical installation and storing the detected alarm messages in a storage device;
b) defining a specific time range for further processing of the detected alarm messages contained in the specific time range;
c) determining at least one time instant, within the specific time range, at which an output alarm message arrives in the technical installation; and
d) transmitting the at least one time instant to a control device, which is configured to display the detected alarm messages.

2. The method as claimed in claim 1, wherein the following steps are performed within the scope of determining the at least one time instant:
i) totaling all active alarm messages in the specific time range and determining an associated totaling function;
ii) identifying local minima of the associated totaling function; and
iii) transmitting the identified local minima to the control device.

3. The method as claimed in claim 1, wherein the local minima are transmitted sorted based on a specific criterion to the control device.

4. The method as claimed in claim 2, wherein the local minima are transmitted sorted based on a specific criterion to the control device.

5. The method as claimed in claim 3, wherein the specific criterion comprises a value according to an amount of the local minima.

6. The method as claimed in claim 4, wherein the specific criterion comprises a value according to an amount of the local minima.

7. The method as claimed in claim 1, wherein the control device is configured to predetermine the specific time range in accordance with step b).

8. The method as claimed in claim 1, wherein the identified local minima and detected alarm messages are presented to an operator of the technical installation in an automated manner via the control device; and wherein the detected alarm messages have accumulated in a specific range about the local minima in the technical installation.

9. An operation station server of a management system in a technical installation, comprising:
a processor; and
memory;
wherein the operation station server is configured to:
a) detect alarm messages arriving in the management system of the technical installation and store the detected alarm messages in a storage device;
b) define a specific time range for further processing of the detected alarm messages contained in the specific time range;
c) determine at least one time instant, within the specific time range, at which an output alarm message arrives in the technical installation; and
d) transmit the at least one time instant to a control device, which is configured to display the detected alarm messages.
